(19) United States
(12) Patent Application Publication
(10) Pub. No.: US 2007/0099613 A1
(43) Pub. Date: May 3, 2007

(54) Method and system for forwarding calls to a secondary wireless network using a multi-protocol wireless device

(75) Inventors: John M. Burgan, North Palm Beach, FL (US); Edward A. Diaz, Miami, FL (US); Tal Mor, Coral Springs, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/263,162

(22) Filed: Oct. 31, 2005

(51) Int. Cl. H04Q 7/20

(52) U.S. Cl. 455/435.2

(57) ABSTRACT

A multi-protocol phone call routing system (10) and method (40) can include a wireless transceiver (22) capable of operating on a primary wireless network (24) and at least one alternative wireless network (32), and a processor coupled to the wireless transceiver. The transceiver can be programmed to monitor (44 or 52) signal quality, location or cost on the primary wireless network or on the alternative wireless network and request (48) to carry traffic on the primary wireless network or the alternative wireless network. The system can be further programmed to request (54) canceling forwarded calls to the alternative wireless network transceiver portion when the signal quality on the primary wireless network reaches above the predetermined threshold and to transfer calls back to the primary wireless network when the signal quality on the primary wireless network reaches above the predetermined threshold and optionally power down (56) the alternative wireless network transceiver.

### FIELD OF THE INVENTION

This invention relates generally to communication systems, and more particularly to a method and system for forwarding calls using a multi-protocol wireless device and network.

### BACKGROUND OF THE INVENTION

In a cellular phone system using multi-protocol handsets (iDEN/CDMA for example), determining which network to use for voice calls at any given time can involve additional cost and complexity. The typical method as illustrated in the system 10 FIG. 1 would be to assign multiple phantom id's (or phone numbers) 15 and 17 to a multi-protocol handset 18 for use on each of its supported protocols 14 and 16 respectively. Then a separate infrastructure switch 16 that owns the users real (public) phone number 12 monitors signal quality on each of the available protocols. When a call is placed to the users real phone number 12, the infrastructure switch 13 will determine which protocol 14 or 16 (and therefore phantom id 15 or 17) is best to use, and will route the call appropriately through the chosen protocol. The extra infrastructure switch 13 that monitors signal quality on the various protocols and routes the call adds extra cost to the network and system 10, and requires coordination of multiple operators to route calls.

WLAN phones can use a system similar to that described above in which a PBX routes calls between an internal wireless network and an external phone provider, but no known systems use the methods described herein in a handset to achieve similar functionality.

### SUMMARY OF THE INVENTION

Embodiments in accordance with the present invention can use methods in a handset or mobile wireless device to determine which network is most appropriate for handling a call at any given time. The wireless device can then use standard network call forwarding methods to route calls to the correct real or phantom phone number associated with the wireless device. The handset can determine which protocol is most appropriate using various methods that can be analyzed by the handset, including signal quality, location within the network (using GPS or cell tower identifiers), and costs associated with using the various networks available.

In a first embodiment of the present invention, a multi-protocol phone call routing system can include a wireless transceiver capable of operating on a primary wireless network and at least one alternative wireless network, and a processor coupled to the wireless transceiver. The primary wireless network can be an IDEN network and an alternative wireless network can be a CDMA network although the embodiments herein are certainly not limited thereto and can include other networks within contemplation of the scope of the claims. For example, the primary network can be one among an iDEN, UMTS, GSM, or CDMA wireless networks and the alternative wireless network can be one among IDEN, UMTS, GSM, or CDMA wireless networks. The transceiver can be programmed to monitor signal quality (such as signal strength or bit error rate), location or cost on the primary wireless network or on the at least one alternative wireless network and request to carry traffic on the primary wireless network or the at least one alternative wireless network by the wireless transceiver based on analysis at the wireless transceiver of the signal quality or location or cost when using the primary wireless network or the at least one alternative wireless network. The system can be further programmed to monitor signal quality on the primary wireless network, power-up an alternative wireless network transceiver portion of the wireless transceiver if a signal quality on the primary wireless network falls below a predetermined threshold, and request to forward calls to a primary wireless network transceiver portion of the wireless transceiver to the alternative wireless network transceiver portion. The system can be further programmed to request canceling forwarded calls to the alternative wireless network transceiver portion when the signal quality on the primary wireless network reaches above the predetermined threshold and to transfer calls back to the primary wireless network when the signal quality on the primary wireless network reaches above the predetermined threshold and power down the alternative wireless network transceiver. Note, the system can requests to forward calls to the alternative wireless network transceiver portion by transferring calls to a phantom phone number.

In a second embodiment of the present invention, a multi-protocol cellular phone can include a wireless transceiver capable of operating on a primary wireless network or an alternative wireless network, and a processor coupled to the wireless transceiver. The transceiver can be programmed to power-up the wireless transceiver on the primary wireless network, monitor signal quality on the primary wireless network, power-up the wireless transceiver on the alternative wireless network if the wireless transceiver detects a signal quality below a predetermined threshold on the primary wireless network, and request to forward calls to the primary wireless network to a phantom phone number on the alternative wireless network when the primary wireless network falls below a predetermined threshold using internet traffic through the alternative wireless network. The multi-protocol cellular phone can be further programmed to cancel the request to forward calls to the phantom phone number when the wireless transceiver detects a signal quality above the predetermined threshold on the primary wireless network. The multi-protocol cellular phone can be further programmed to power-down the wireless transceiver on the alternative wireless network once the wireless transceiver detects the signal quality above the predetermined threshold on the primary wireless network. Although the primary and secondary networks can be any number of networks, one example can have an iDEN wireless network for the primary wireless network and a CDMA wireless network for the alternative wireless network.

In a third embodiment of the present invention, a method of forwarding calls to a secondary wireless network using a mobile multi-protocol wireless device can include the steps at the multi-protocol wireless device of monitoring a signal quality on a primary wireless network, requesting to carry traffic on an alternative wireless network if the signal quality on the primary wireless network falls below a predetermined threshold, and requesting to forward calls to the primary wireless network to the alternative wireless network (to a phantom phone number, for example) when the primary wireless network falls below the predetermined threshold. The request to forward calls to the phantom phone number on the alternative wireless network can be done using internet traffic on the alternative wireless network. The method can further include the step of requesting to cancel forwarding calls to the alternative wireless network when the signal quality on the primary wireless network reaches above the predetermined threshold. The method can further include the steps of powering-up an alternative wireless network transceiver when the signal quality (such as signal strength or bit error rate) on the primary wireless network falls below the predetermined threshold and powering down the alternative wireless network transceiver when the signal quality on the primary wireless network reaches above the predetermined threshold. The method can further include the step of powering-up the multi-protocol wireless device on the primary wireless network and camping on the primary wireless network. The method can further include requesting to forward calls to the primary wireless network to the alternative wireless network when the primary wireless network analyzes a cost factor or a location and determines a predetermined cost advantage for switching to the alternative wireless network.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an existing system using an infrastructure switch to switch between communication protocols.

FIG. 2 is a multi-protocol phone call routing system having a wireless transceiver capable of operating on a primary wireless network or at least one alternative wireless network in accordance with an embodiment of the present invention.

FIG. 3 is the multi-protocol phone call routing system of FIG. 1 illustrating the routing of a phone call to a secondary network using a phantom phone number when a signal quality is below a predetermined threshold in accordance with an embodiment of the present invention.

FIG. 4 is a flow chart illustrating a method of forwarding calls to a secondary wireless network using a mobile multi-protocol wireless in accordance with an embodiment of the present invention.

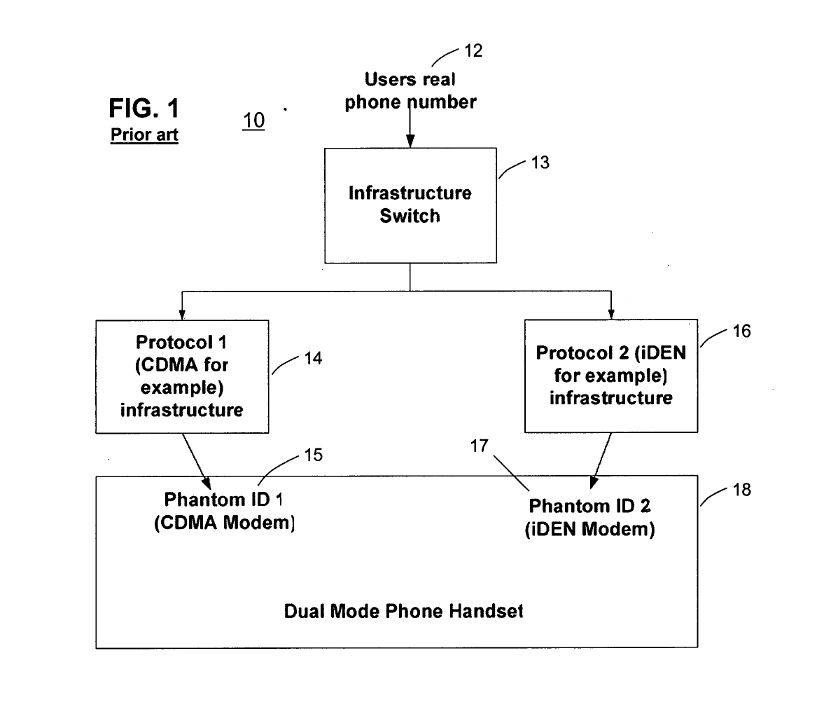

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

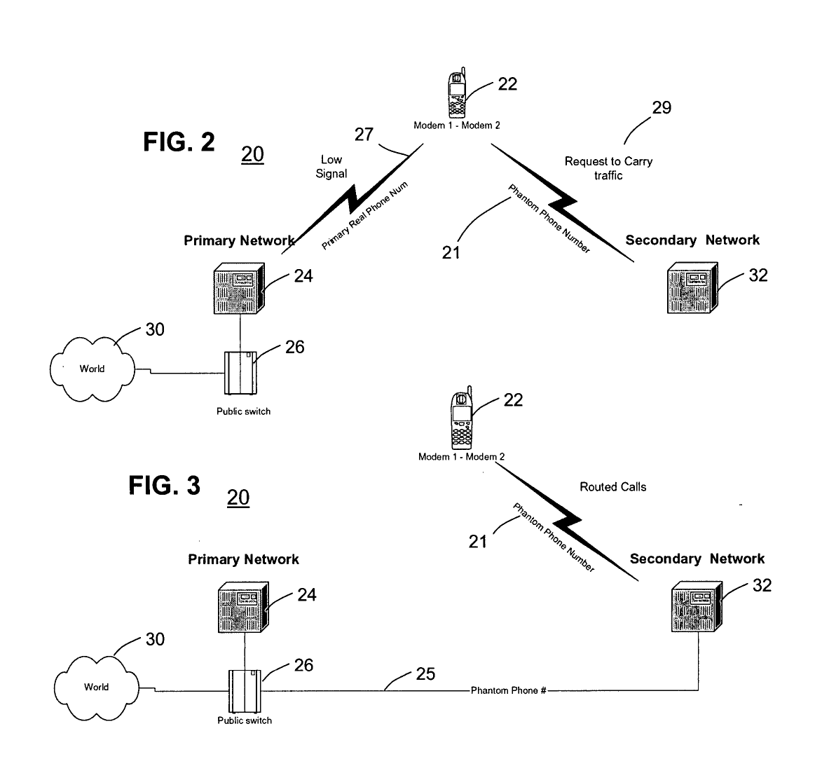

Referring to FIGS. 2 and 3, a dual protocol handset or mobile radio 22 in a multi-protocol phone call routing system 20 can have the real public phone number 27 assigned to one of its protocols (using a primary network 24 such as an IDEN network for example), and a phantom phone number 21 assigned to each of the alternate protocols (using an secondary or alternate network 32 such as a CDMA network for example). Under normal conditions, the mobile radio 22 will use the primary network 24 and a public switch 26 to communicate with other networks 30 throughout the world. In the case of an iDEN network as the primary network 24, when the iDEN modem in the handset or mobile radio 22 determines through signal quality (using signal strength, bit error rate, or other methods) that it can no longer provide service, the mobile radio can generate a call forwarding request 29 to send any calls received at the real public phone number to the phantom phone number used by the CDMA modem (and the alternate or secondary network 32). The handset or mobile radio 22 can send the call forwarding request by various methods including using a control channel in the primary network or using packet data traffic (through the internet) on either the primary or alternate protocol. Then, the mobile radio 22 routes calls via the phantom phone number 21 using the alternate or secondary network 32.

When the handset determines that the primary network 24 is now capable of handling voice traffic again, it will use one of the available methods to send a request to the network to cancel call forwarding. The primary public phone number will then ring through primary carrier again.

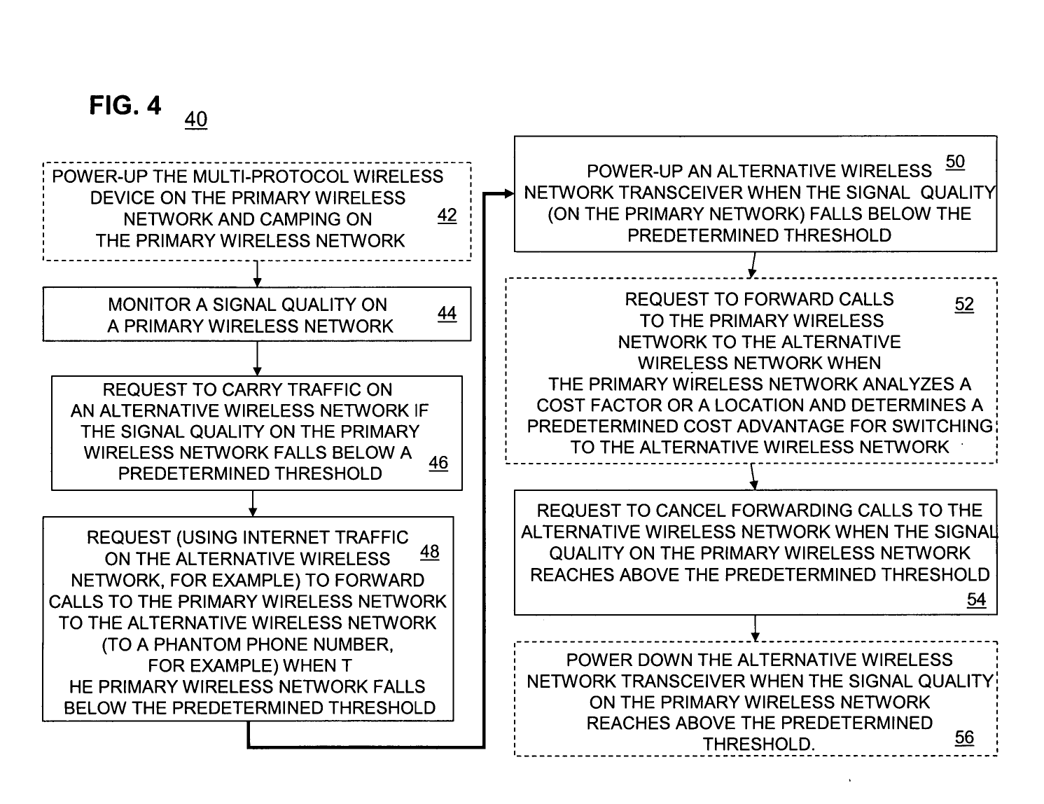

Referring to FIG. 4, a flow chart illustrating a method 40 of forwarding calls to a secondary wireless network using a mobile multi-protocol wireless device can include the step 42 of powering-up the multi-protocol wireless device on the primary wireless network and camping on the primary wireless network. The multi-protocol wireless device can monitor a signal quality on a primary wireless network at step 44, request to carry traffic on an alternative wireless network if the signal quality on the primary wireless network falls below a predetermined threshold at step 46, and request to forward calls to the primary wireless network to the alternative wireless network (to a phantom phone number, for example) when the primary wireless network falls below the predetermined threshold at step 48. The request to forward calls to the phantom phone number on the alternative wireless network can be done using internet traffic on the alternative wireless network. The method 40 can further include the step 50 of powering-up an alternative wireless network transceiver when the signal quality (such as signal strength or bit error rate) on the primary wireless network falls below the predetermined threshold. The method 40 can further include the optional step 52 of requesting to forward calls to the primary wireless network to the alternative wireless network when the primary wireless network analyzes a cost factor or a location and determines a predetermined cost advantage for switching to the alternative wireless network. The method 40 can further include the step 54 of requesting to cancel forwarding calls to the alternative wireless network when the signal quality on the primary wireless network reaches above the predetermined threshold. The method 40 can also optionally include the step 56 of powering down the alternative wireless network transceiver when the signal quality on the primary wireless network reaches above the predetermined threshold.

In a practical implementation using a dual mode phone that used an iDEN network as the primary network and CDMA as the alternative network, such a method can include the steps at the dual mode phone of powering up and camping on the iDEN network on a primary phone number and monitoring for a low signal strength on the iDEN network before powering up a CDMA modem or transceiver. In one implementation using internet traffic through the CDMA modem, the phone can request the iDEN network to forward calls to a phantom CDMA phone number. Once the dual mode phone detects an adequate signal on the iDEN network, the dual mode phone can cancel call forwarding and can power down CDMA modem.

Using the method 40 described above, the handset does not necessarily need to be continuously camped on both networks. The secondary modem (CDMA in this case) can be powered down when it is not needed. The secondary modem would only be powered up when the primary network (iDEN) can not receive calls and the primary phone number has been forwarded.

Note, the method described above also supports multiple billing methods as well. For example, a first carrier and a second carrier can negotiate rates and billing, and seamlessly bill the customer for one phone number and all his calls even though two protocols are used to deliver service. Alternately, in a different embodiment, the phone subscriber can open two separate accounts, and use CDMA and GSM for example to get a larger coverage area without either carrier knowing that there is another protocol in use for some calls.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A multi-protocol phone call routing system, comprising:
a wireless transceiver capable of operating on a primary wireless network and at least one alternative wireless network; and
a processor coupled to the wireless transceiver, wherein the processor is programmed to:
monitor signal quality, location or cost on the primary wireless network or on the at least one alternative wireless network; and
request to carry traffic on the primary wireless network or the at least one alternative wireless network by the wireless transceiver based on analysis at the wireless transceiver of the signal quality or location or cost when using the primary wireless network or the at least one alternative wireless network.

2. The multi-protocol phone call routing system of claim 1, wherein the system is further programmed to:
monitor signal quality on the primary wireless network;
power-up an alternative wireless network transceiver portion of the wireless transceiver if a signal quality on the primary wireless network falls below a predetermined threshold; and
request to forward calls to a primary wireless network transceiver portion of the wireless transceiver to the alternative wireless network transceiver portion.

3. The multi-protocol phone call routing system of claim 2, wherein the system is further programmed to request canceling forwarded calls to the alternative wireless network transceiver portion when the signal quality on the primary wireless network reaches above the predetermined threshold.

4. The multi-protocol phone call routing system of claim 3, wherein the system is further programmed to transfer calls back to the primary wireless network when the signal quality on the primary wireless network reaches above the predetermined threshold and power down the alternative wireless network transceiver.

5. The multi-protocol phone call routing system of claim 2, wherein the system requests to forward calls to the alternative wireless network transceiver portion by transferring calls to a phantom phone number.

6. The multi-protocol phone call routing system of claim 1, wherein the step of monitoring signal quality comprises monitoring signal strength or bit error rate.

7. The multi-protocol phone call routing system of claim 1, wherein the primary wireless network is an iDEN network and the at least one alternative wireless network is a CDMA network.

8. A multi-protocol cellular phone, comprising:
a wireless transceiver capable of operating on a primary wireless network or an alternative wireless network; and
a processor coupled to the wireless transceiver, wherein the processor is programmed to:
power-up the wireless transceiver on the primary wireless network;
monitor signal quality on the primary wireless network;
power-up the wireless transceiver on the alternative wireless network if the wireless transceiver detects a signal quality below a predetermined threshold; and
request to forward calls to the primary wireless network to a phantom phone number on the alternative wireless network when the primary wireless network falls below a predetermined threshold using internet traffic through the alternative wireless network.

9. The multi-protocol cellular phone of claim 8, wherein the multi-protocol cellular phone is further programmed to cancel the request to forward calls to the phantom phone number when the wireless transceiver detects a signal quality above a predetermined threshold on the primary wireless network.

10. The multi-protocol cellular phone of claim 9, wherein the multi-protocol cellular phone is further programmed to power-down the wireless transceiver on the alternative wireless network once the wireless transceiver detects the signal quality above the predetermined threshold.

11. The multi-protocol cellular phone of claim 8, wherein the primary wireless network is one among an iDEN, UMTS, GSM, or CDMA wireless network and the alternative wireless network is one among a CDMA, UMTS, GSM or iDEN wireless network.

12. A method of forwarding calls to a secondary wireless network using a mobile multi-protocol wireless device, comprising the steps at the multi-protocol wireless device of:
monitoring a signal quality on a primary wireless network;
requesting to carry traffic on an alternative wireless network if the signal quality on the primary wireless network falls below a predetermined threshold; and
requesting to forward calls to the primary wireless network to the alternative wireless network when the primary wireless network falls below the predetermined threshold.

13. The method of claim 12, wherein the method further comprises the step of requesting to cancel forwarding calls to the alternative wireless network when the signal quality on the primary wireless network reaches above the predetermined threshold.

14. The method of claim 12, wherein the method further comprises the step of powering-up an alternative wireless network transceiver when the signal quality on the primary wireless network falls below the predetermined threshold.

15. The method of claim 14, wherein the method further comprises the step of powering down the alternative wireless network transceiver, when the signal quality on the primary wireless network reaches above the predetermined threshold.

16. The method of claim 12, wherein the step of requesting to forward calls comprise requesting to forward calls to a phantom phone number.

17. The method of claim 12, wherein the method further comprises the step of powering-up the multi-protocol wireless device on the primary wireless network and camping on the primary wireless network.

18. The method of claim 12, wherein the method further comprises the step of powering up the multi-protocol wireless device on the alternative wireless network when a signal strength below a predetermined threshold is detected on the primary wireless network.

19. The method of claim 12, wherein the multi-protocol wireless device requests forwarding calls on the primary wireless network to a phantom phone number on the alternative wireless network using internet traffic on the alternative wireless network.

20. The method of claim 12, wherein the method further comprises the step of requesting to forward calls to the primary wireless network to the alternative wireless network when the primary wireless network analyzes a cost factor or a location and determines a predetermined cost advantage for switching to the alternative wireless network.
